(19) United States
(12) Patent Application Publication
(10) Pub. No.: US 2007/0231215 A1
(43) Pub. Date: Oct. 4, 2007

(54) Pipette tip

(75) Inventors: Kazunori Mototsu, Kobe (JP); Toshikatsu Fukuju, Akashi (JP); Hiroto Toyoshima, Kobe (JP)

Correspondence Address: SUGHRUE MION, PLLC, 2100 PENNSYLVANIA AVENUE, N.W., SUITE 800, WASHINGTON, DC, 20037, US

(73) Assignee: SYSMEX CORPORATION, Kobe-shi (JP)

(21) Appl. No.: 11/730,471

(22) Filed: Apr. 2, 2007

(30) Foreign Application Priority Data
Mar. 31, 2006 (JP) 2006-096794

(51) Int. Cl. B01L 3/02

(52) U.S. Cl. 422/100

(57) ABSTRACT

The present invention is to present a disposable pipette tip that can easily prevent a tight fit with another pipette tip without providing a separating mechanism in a supplying apparatus. The disposable pipette tip comprises: an attachment section for being attached to the dispensing device; and a liquid containing section for containing a liquid aspirated by the dispensing device, which is continually located to the attachment section, has a tapered distal end and comprises a tight fit preventing part which is located adjacent to the tapered distal end and prevents a tight fit with another pipette tip.

### FIELD OF THE INVENTION

The present invention relates to a disposable pipette tip used in a dispensing device for dispensing reagent or samples such as blood, urine or the like.

### BACKGROUND

In analyzers that have a dispensing device for aspirating and discharging liquid such as sample and reagent, it is essential to prevent contamination of the sample or reagent aspirated by the dispensing device which could be caused by mixing the sample or reagent used in the previous analysis with a subsequent sample or reagent aspirated by the dispensing device. Therefore, a disposable pipette tip is used at the distal end of the dispensing nozzle of the dispensing device.

This type of pipette tip is housed and stored in a large capacity storage tank in order to perform the continuous analysis operations. The pipette tip removed from the storage tank must be supplied to the attachment position of the dispensing nozzle in order to attach the pipette tip to the dispensing nozzle.

The shape of the pipette tip is configured as a conical shape that tapers from the proximal end toward the distal end of the pipette tip as disclosed in, for example, U.S. Pat. No. D468,832. However, when a large quantity of pipette tips have been randomly accumulated in a storage tank, a particular pipette tip may become inserted into the opening at the proximal end of another pipette tip. And, when the outer wall surface of the pipette tip on the top side makes relative contact with the inner wall surface of the pipette tip on the bottom side, the pipette tip on the top side may fit tightly with the pipette tip on the bottom side. When pipette tips are supplied in this mutually tight fitted condition, a pipette tip may not be efficiently supplied because faults are likely to occur such as the tight fitted pipette tips may interfere with the structural members of the supplying apparatus and become jammed in the supply path. Moreover, the liquid aspirating and discharging operations of the dispensing device may also be hindered.

Structures such as that disclosed in U.S. Pat. No. 6,799,696 hold the pipette tip on the top side of a mutually overlapped pair of pipette tips during the supply operation so as to allow the pipette tip on the bottom side to drop by force of its own weight and thus resolve the overlap of pipette tips.

However, although the structure disclosed in U.S. Pat. No. 6,799,696 may resolve the overlap of pipette tips, it is difficult to separate mutually tight fitted pipette tips one by one. Moreover, providing a separating mechanism in the supplying apparatus such as the structure disclosed in U.S. Pat. No. 6,799,696 increases the complexity of the apparatus.

### SUMMARY

A first aspect of the present invention is a disposable pipette tip used in a dispensing device, comprising: an attachment section for being attached to the dispensing device; and a liquid containing section for containing a liquid aspirated by the dispensing device, which is continually located to the attachment section, has a tapered distal end and comprises a tight fit preventing part which is located adjacent to the tapered distal end and prevents a tight fit with another pipette tip.

A second aspect of the present invention is a disposable pipette tip used in a dispensing device, comprising: an attachment section for being attached to the dispensing device; and a body being continually located to the attachment section, wherein the body comprises a tapered distal end part, a first part being continually located to the tapered distal end part, and a second part being continually located to the first part and having an internal diameter that decreases toward the first part, and wherein the external diameter of the end of the first part on the tapered distal end part side is larger than the internal diameter of the end of the second part on the first part side.

A third aspect of the present invention is a disposable pipette tip used in a dispensing device, comprising: an attachment section for being attached to the dispensing device; a tapered part having a tapered shape; and an intermediate portion being continually located to the attachment section and the tapered part, wherein the tapered part comprises a tight fit preventing part which is located adjacent to the distal end of the tapered part and prevents a tight fit with another pipette tip.

### BRIEF DESCRIPTION OF THE DRAWINGS

FIG. 1 is a frontal view of an embodiment of a pipette tip 1 of the present invention;

FIG. 2 is a top view of the pipette tip 1 shown in FIG. 1;

FIG. 3 is a view on the m-m cross section of the pipette tip 1 shown in FIG. 1;

FIG. 4 is a vertical section view showing overlapped two pipette tips;

FIG. 5 is a partial enlargement of the overlapped two pipette tips 1 shown in FIG. 4;

FIG. 6 is a perspective view of a pipette tip supplying apparatus for supplying the pipette tip 1;

FIG. 7 is a perspective view of a tip storage section 33 for storing the pipette tips 1;

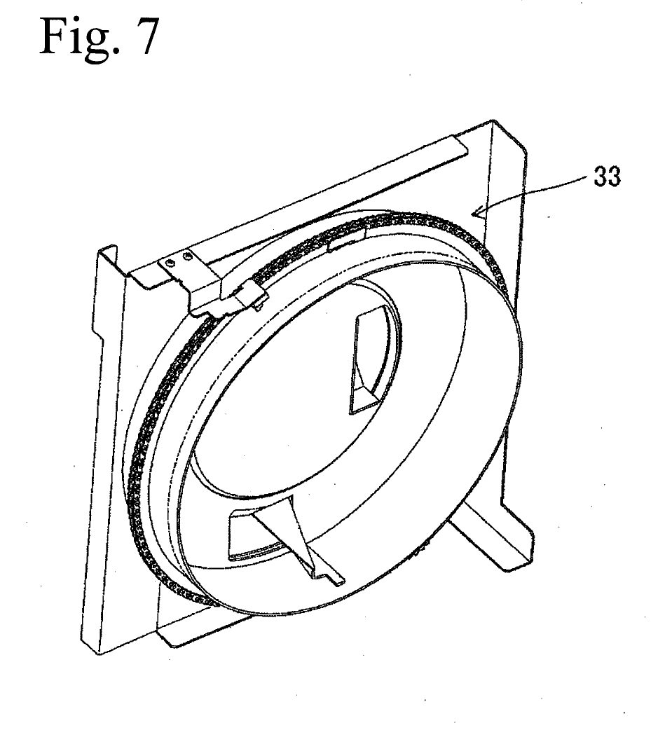

FIG. 8 illustrates the condition when a pipette tip 1 is attached to a nozzle part 54a of the sample dispensing arm;

FIG. 9 illustrates the condition of a pipette tip 1 attached to a nozzle part 54a of the sample dispensing arm; and

FIGS. 10 and 11 are vertical cross section views of other embodiments of the pipette tip of the present invention.

### DETAILED DESCRIPTION OF THE EMBODIMENT

Embodiments of the pipette tip of the present invention are described hereinafter with reference to the drawings.

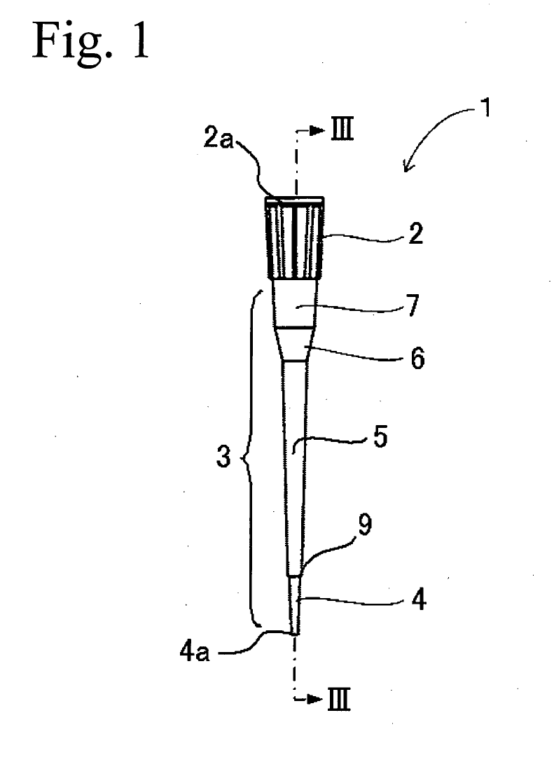

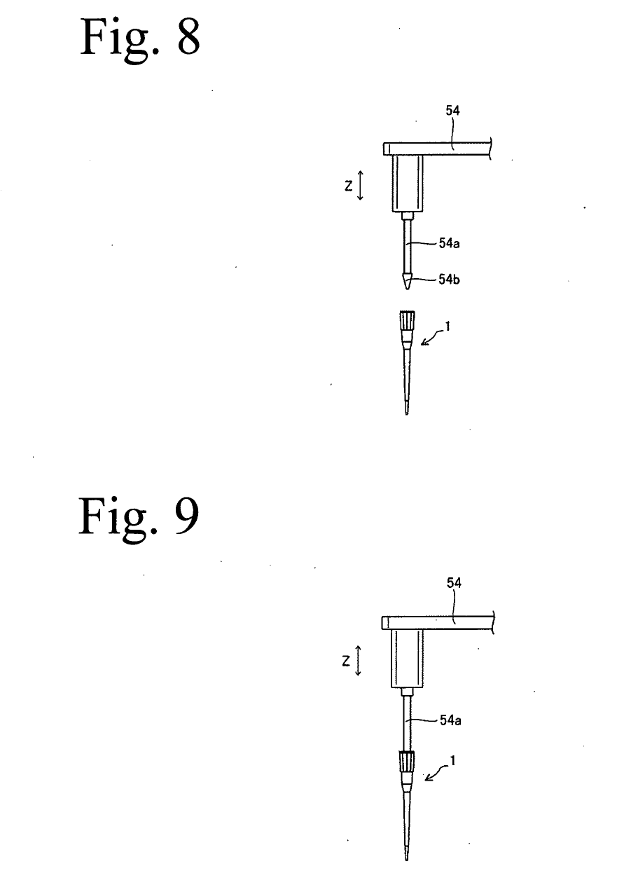

FIG. 1 is a frontal view of an embodiment of a pipette tip 1 of the present invention. As shown in FIG. 1, a pipette tip 1 is provided with an attachment section 2 for being attached to the distal end of a nozzle part 54a as shown in FIG. 8, and a liquid containing section 3 for containing aspirated liquid and which is connected to the attachment section 2. The liquid containing section 3 is provided with a body section 7 connected to the attachment section 2, inclined section 6 connected to the body section 7 on the distal end side of the pipette tip 1, main containing section 5 connected to the inclined section 6 on the distal end side of the pipette tip 1, and a tip section 4 connected to the main containing section 5 on the distal end side of the pipette tip 1. The pipette tip 1 is entirely formed of semitransparent polypropylene. The pipette tip 1 is integratedly formed as a single unit. And the pipette tip 1 is disposable.

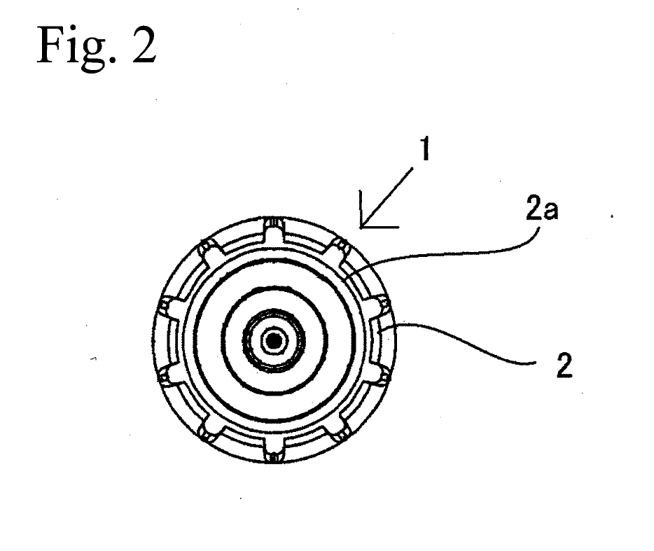

FIG. 2 is a top view of the pipette tip 1. As shown in FIGS. 1 and 2, the shape of the inner wall surface and outer wall surface at the horizontal cross section of the pipette tip 1 is approximately circle from the attachment section 2 to the tip section 4. Moreover, the outer wall surface of the attachment section 2 is formed in a concavo-convex shape.

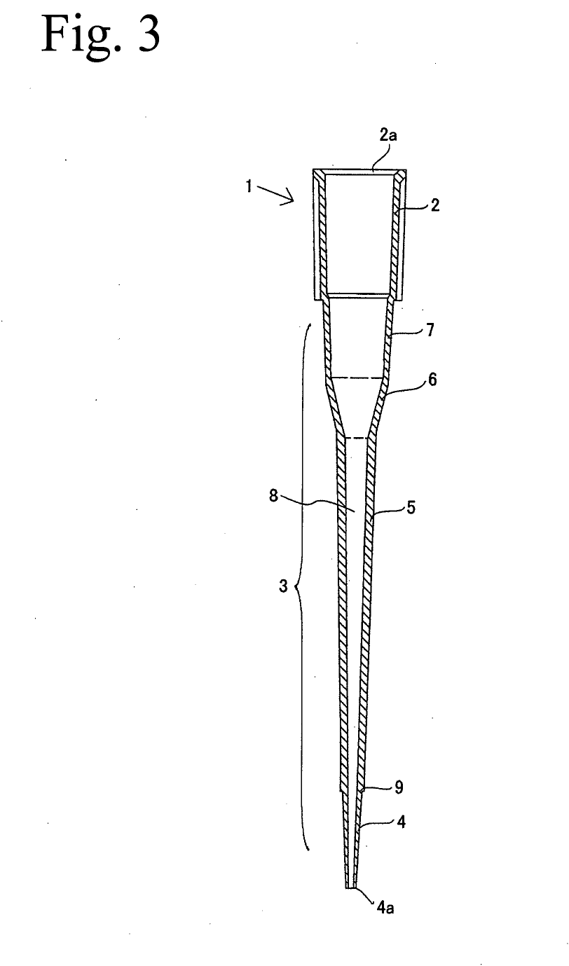

FIG. 3 shows the III-III cross section of the pipette tip 1 of FIG. 1. As shown in FIG. 3, the pipette tip 1 is provided with an aspiration-discharge opening 4a for aspirating and discharging liquid at the distal end of the pipette tip 1, and a proximal end opening 2a at the proximal end of the pipette tip 1 into which is inserted a distal end 54b of the nozzle section 54a shown in FIG. 8, and an internal hole 8 is formed throughout the interior from the aspiration-discharge opening 4a of the tip section 4 to the proximal end opening 2a of the attachment section 2.

The inner wall surface of the pipette tip 1 is tapered with a decreasing diameter and is smoothly continuous from the end of the main containing section 5 on the inclined section 6 side to the aspiration-discharge opening 4a of the tip section 4. The outer wall surface of the main containing section 5 and tip section 4 of the pipette tip 1 are also tapered with a decreasing diameter toward the distal end of the pipette tip 1 via a smoothly continuous surface. However, the outer wall surface of the main containing section 5 is provided with a stepped section 9 at the connecting position of the main containing section 5 and tip section 4, and which is connected step-like to the outer wall surface of the tip section 4. The external diameter of the stepped section 9 (external diameter of the end of the main containing section 5 on the tip section 4 side) is larger than that of the end of the tip section 4 on the main containing section 5 side, and, specifically, the external diameter of the stepped section 9 is 1.8 mm, whereas the external diameter of the end of the tip section 4 on the main containing section 5 side is 1.45 mm.

The inner wall surface and outer wall surface of the inclined section 6 is tapered with a diameter that increases toward the body section 7. Moreover, the inner wall surface of the inclined section 6 is continuous so as to incline relative to the inner wall surface of the main containing section 5. As a result, the inner diameter of the pipette tip 1 increases from the aspiration-discharge opening 4a of the tip section 4 to the end of the main containing section 5 on the inclined section 6 side at a predetermined rate, meanwhile the inner diameter of the pipette tip 1 increases from the end of the inclined section 6 on the main containing section 5 side to the end of the inclined section 6 on the body 7 side at a greater rate than the predetermined rate. Specifically, the inner diameter of the pipette tip 1 increases 0.6 mm in conjunction with an advance of 1 mm in the direction of the proximal end opening 2a from the end of the inclined section 6 on the main containing section 5 side to the end of the inclined section 6 on the body 7 side, in contrast to the inner diameter of the pipette tip 1 that increases 0.04 mm in conjunction with an advance of 1 mm in the direction of the proximal end opening 2a from the aspiration-discharge opening 4a of the tip section 4 toward the end of the main containing section 5 on the inclined section 6 side. The outer wall surface of the inclined section 6 is continuously inclined relative to the outer wall surface of the main containing section 5 similar to the inner wall surface of the inclined section 6.

The body section 7 and the attachment section 2 are approximately cylindrical, and the inner wall surface and outer wall surface of the body section. 7 and the attachment section 2 are tapered so that the diameters respectively increase in the direction toward the proximal end opening 2a of the attachment section 2.

The external diameter of the stepped section 9 is formed so as be larger than the inner diameter of the connecting position of the main containing section 5 and the inclined section 6. Specifically, the inner diameter of the connecting position of the main containing section 5 and the inclined section 6 is 1.7 mm, whereas the external diameter of the stepped section 9 is 1.8 mm.

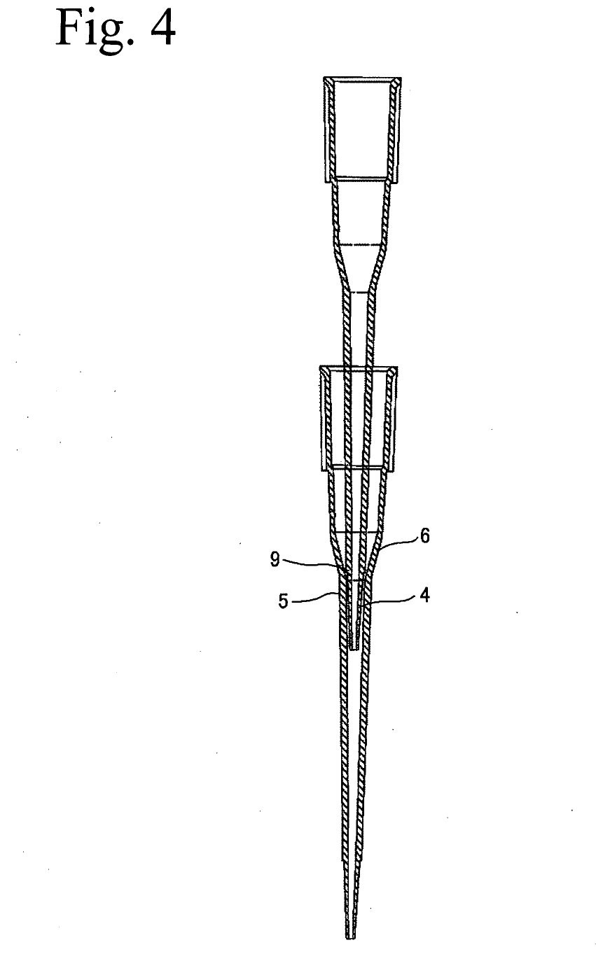

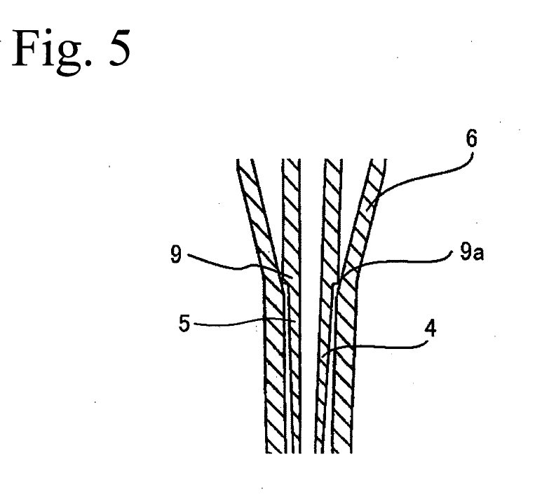

The pipette tip 1 having the above mentioned configuration may create a mutual two-stage overlap of two pipette tips 1 when inserted into another pipette tip 1 from the proximal end opening 2a. FIG. 4 is a vertical cross section view of such a situation of a mutual two-stage overlapping of two pipette tips 1, and FIG. 5 is an enlargement showing the periphery of the stepped section 9 of the top side pipette tip 1 of the mutual two-stage overlapping pipette tips 1. As mentioned above, the inner wall surface of the inclined section 6 of the pipette tip 1 is tapered with a diameter that increases from the end of the inclined section 6 on the main containing section 5 side to the end of the inclined section 6 on the body section 7 side. Furthermore, the inner wall surface of the inclined section 6 is connected to the inner wall surface of the main containing section 5 so as to incline relative to the inner wall surface of the main containing section 5. The external diameter of the stepped section 9 is formed so as be larger than the inner diameter of the connecting position of the main containing section 5 and the inclined section 6. When pipette tips 1 having this configuration become engaged together in the previously described mutual two-stage overlap, only the angle part 9a provided on the outer wall surface of the stepped section 9 of the top side pipette tip 1 comes into contact with the inner wall surface of the inclined section 6 of the bottom side pipette tip 1, such that the outer wall surface of the top side pipette tip 1 does not make contact with the inner wall surface of the bottom side pipette tip 1. Therefore, it is possible to prevent one pipette tip 1 from fitting tightly with another even in the case of a mutual two-stage overlapping of two pipette tips 1.

The example below describes a pipette tip supplying apparatus 30 for supplying the pipette tip 1 of the present invention, a transport rack (not shown in the drawings) for transporting the pipette tips 1 supplied by the pipette tip supplying apparatus 30 to an attachment position of the sample dispensing arm (not shown in the drawings), and a sample dispensing arm for aspirating-discharging a sample via an attached pipette tip 1.

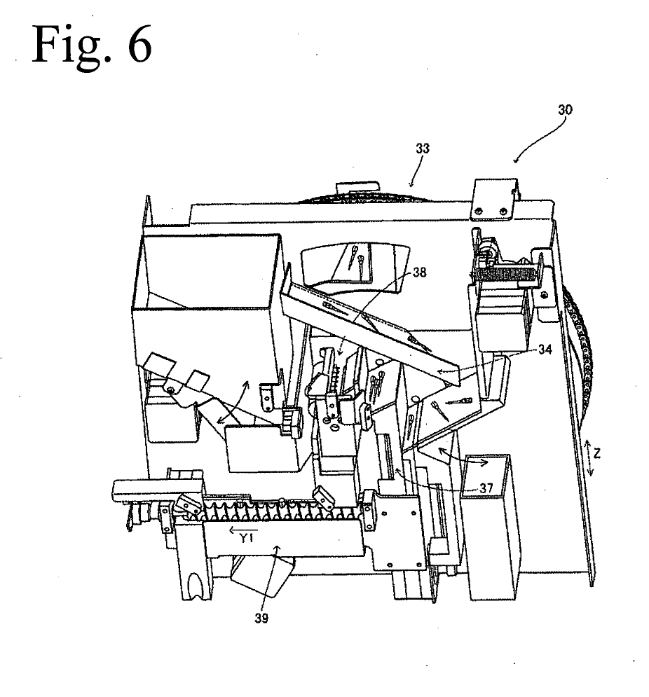

The pipette tip supplying apparatus 30 shown in FIG. 6 functions to supply a large quantity of pipette tips 1 accommodated in the tip storage section 33 one by one to a transport rack. As shown in FIG. 6, the pipette tip supplying apparatus 30 is configured by the tip storage section 33, transport path 34, sorting device 37, moving sections 38 and 39 and the like.

The tip storage section 33 is capable of accommodating a large quantity of pipette tips 1, and functions to deliver the stored pipette tips 1 to the transport path 34.

The transport path 34 is provided to guide a plurality of pipette tips 1 delivered from the tip storage section 33 to the sorting device 37.

The sorting device 37 is provided to sort one by one the plurality of pipette tips 1 received from the transport path 37, and deliver the individually sorted pipette tips 1 to the moving section 38.

The moving section 38 is provided to move the pipette tips 1 delivered from the sorting device 37 to the moving section 39.

The moving section 39 is provided to move the pipette tips 1 delivered from the moving section 38 in the Y1 direction shown in FIG. 6, and deliver the pipette tips 1 to the transport rack.

The transport rack is provided to then transport the pipette tips 1 delivered from the moving section 39 to the attachment position of the sample dispensing arm.

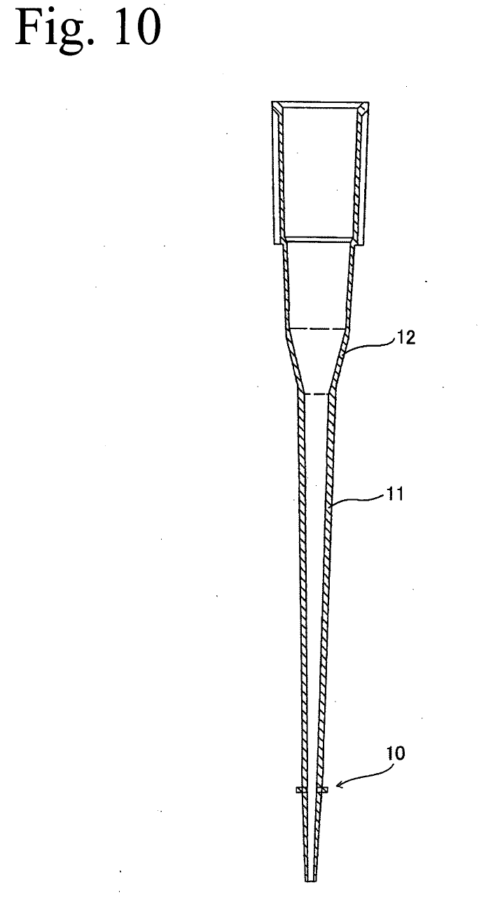

The sample dispensing arm functions to attach the pipette tip 1 (refer to FIG. 9), aspirate a predetermined amount of sample, and discharged the aspirated sample into a cuvette disposed at a predetermined position. The sample dispensing arm is provided with an arm part 54 capable of moving in vertical directions (Z direction), and the distal end of the arm part 54 is provided with a nozzle part 54a for aspirating and discharging sample. The pipette tip 1 transported by the transport rack is attached to the distal end 54b of the nozzle part 54a.

The handling of the pipette tip 1 in the pipette tip 1 supplying operation performed by the pipette tip supplying apparatus 30, and the sample aspirating-discharging operations performed by the sample dispensing arm are described in detail below.

A large quantity of pipette tips 1 are first accommodated within the tip storage section 33. In this way the large quantity of pipette tips 1 randomly collect within the tip storage section 33. When a large quantity of pipette tips with a tapered configuration are collected randomly, a given pipette tip may overlap another so as to be inserted through the proximal end opening of the other pipette tip and fit tightly with another under the weight of the large quantity of pipette tips. The tight fitted pipette tips can not be easily separated. However, since the pipette tip 1 is provided with the previously described configuration, such tight fit of pipette tips 1 is readily prevented even when a large quantity of pipette tips 1 are randomly collected within the tip storage section 33.

Then, a plurality of pipette tips 1 are moved from the tip storage section 33 to the transport path 34. These pipette tips 1 are guided to the sorting device 37 by the transport path 34.

The plurality of pipette tips 1 are sorted one by one via the sorting device 37. Although it is difficult to sort the pipette tips one by one when pipette tips are fitted tightly at this time, the pipette tip 1 of the present invention can be separated one by one and transported by the sorting device 37 since the pipette tip 1 of the present invention is configured so as to prevent one pipette tip from fitting tightly with another. Therefore, the pipette tips 1 can be efficiently sorted one by one.

The sorted pipette tips 1 are fed to the moving section 38, which delivers the pipette tips 1 to the moving section 39.

The moving section 39 moves the pipette tips 1 to the transport rack, and the transport rack delivers the pipette tips 1 to the attachment position of the sample dispensing arm. If pipette tips are transported to the moving section 38 and 39 in mutually tight fitted condition, the tight fitted pipette tips may become entangled with the structural members of the moving section 38 and 39 and become jammed in transport path. However, since the pipette tip 1 of the present invention is moved to the moving sections 38 and 39 in separated condition as individual pipette tips 1, the pipette tips 1 are efficiently transported without becoming jammed in the transport path of the moving sections 38 and 39.

After the sample dispensing arm has rotated the nozzle part 54a of the arm section 54 to the pipette tip attachment position, the distal end 54b of the nozzle part 54a of the arm section 54 is press fitted to the proximal end opening 2a of the attachment section 2 of the pipette tip 1 by moving the arm section 54 downward, as shown in FIG. 9. If pipette tips are transported in mutually tight fitted condition to the attachment position of the sample dispensing arm, it is difficult to attach a single individual pipette tip to the distal end 54b of the nozzle part 54a. If tight fitted two pipette tips are attached, it is difficult to efficiently aspirate and discharge sample. However, since the pipette tip 1 of the present invention is transported one by one to the attachment position, a single pipette tip 1 can be easily attached to the distal end 54b of the nozzle part 54a, and as a result aspiration and discharging of sample is performed efficiently. Moreover, since the inner wall surface of the attachment section 2 of the pipette tip 1 is tapered so as to have a diameter that increases toward the proximal end opening 2a of the attachment section 2, the pipette tip 1 is easily and accurately attached to the nozzle part 54a. As a result, the aspiration-discharge opening 4a provided at the tip section 4 can be accurately positioned at the center of the container such as a test tube that accommodates the sample, such that the sample can be efficiently aspirated.

The sample dispensing arm aspirates sample into the pipette tip 1 attached to the distal end 54b of the nozzle part 54a. Then the aspirated sample is accommodated in the liquid containing section 3 of the pipette tip 1. The inner surface of the liquid containing section 3 of the pipette tip 1 has a tapered configuration, with a decreasing inner diameter throughout. Therefore, a minute quantity of sample can be precisely measured since there is a large displacement of the liquid level surface of the aspirated sample. Moreover, excellent cutoff of liquid drip and more precise dispensing are effects resulting from the inner surfaces of the main containing section 5 and tip section 4 of the pipette tip 1 being tapered with decreasing diameter toward the aspiration-discharge opening 4a of the tip section and the mutually continuous smooth inner wall surfaces of the main containing section 5 and tip section 4. Since the outer surface of the tip section 4 of the pipette tip 1 is tapered, the surface area on the outer surface of the distal end of the pipette tip 1 which makes contact with the sample is small. Therefore, there is less sample remaining on the outer surface of the distal end of the pipette tip 1 after the sample has been aspirated, thus improving dispensing accuracy. The sample is then discharged into a cuvette disposed at a predetermined position.

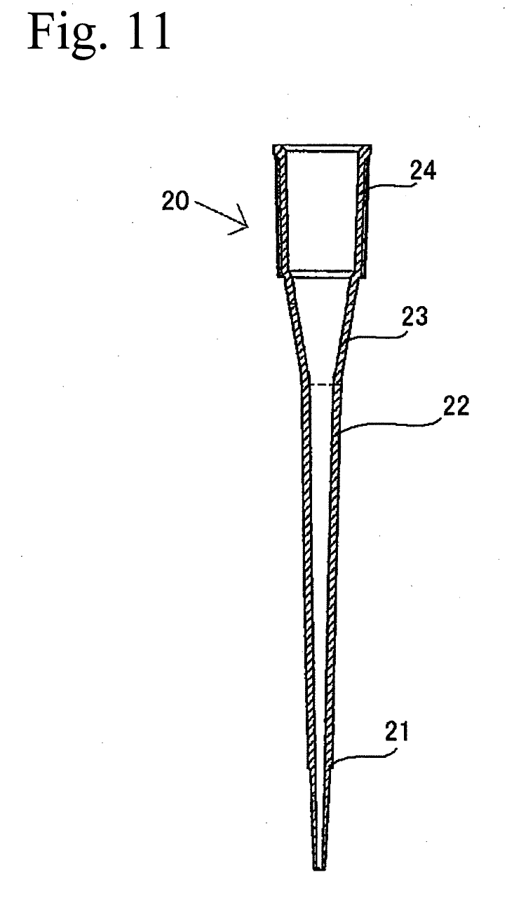

Although the pipette tip 1 of the present embodiment is designed to prevent one pipette tip 1 from fitting tightly with another by providing a stepped section 9 that has a larger external diameter than the inner diameter of the connection position of the main containing section 5 and inclined section 6, a projecting part may also be provided in place of the stepped section 9. The pipette tip shown in FIG. 10 is provided with projections 10 that create an external diameter larger than the internal diameter of the connection position of a main containing section 11 and an inclined section 12, such that tight fit of one pipette tip with another can be prevented via this configuration.

Although the pipette tip 1 is provided with a body section 7 connected to the inclined section 6 and attachment section 2 in the present embodiment, the body section 7 need not necessarily be provided. A pipette tip 20 shown in FIG. 11 is provided with an inclined section 23 connected to an attachment section 24, and a stepped section 21 that has an external diameter that is larger than the inner diameter of the connecting position of a main containing section 22 and the inclined section 23.

Although the pipette tip 1 of the present embodiment is designed to prevent one pipette tip 1 from fitting tightly with another by providing the stepped section 9 on the outer surface of the pipette tip 1, a configuration such as a stepped section, projecting section or the like need not necessarily be provided on the outer surface of the pipette tip 1 to prevent one pipette tip from fitting with another, inasmuch as a configuration such as a projection or the like for preventing one pipette tip from fitting tightly with another may be provided on the inner surface of the pipette tip.

Although the pipette tip 1 is formed so as to be entirely semitransparent in the present embodiment, the pipette tip may also be formed of non-transparent material. In this case, since light will not be transmitted through the pipette tip, the presence of a pipette tip within the tip storage section 33 can be easily detected using a light transmitting type sensor.

Since the pipette tip 1 of the present embodiment has a concavo-convex configuration on the outer wall surface of the attachment section 2, the attachment section 2 of the pipette tip 1 is readily graspable by a user. Therefore, a pipette tip can be easily attached to a dispensing nozzle to perform a sample aspiration operation even when a pipette tip must be manually attached to the distal end of the dispensing nozzle in order to perform a sample aspiration operation.

What is claimed is:

1. A disposable pipette tip used in a dispensing device, comprising:
an attachment section for being attached to the dispensing device; and
a liquid containing section for containing a liquid aspirated by the dispensing device, which is continually located to the attachment section, has a tapered distal end and comprises a tight fit preventing part which is located adjacent to the tapered distal end and prevents a tight fit with another pipette tip.

2. The disposable pipette tip of claim 1, wherein
the tight fit preventing part is provided on the external surface of the liquid containing section.

3. The disposable pipette tip of claim 1, wherein
the tight fit preventing part comprises a stepped part having an external diameter that is larger than that of the liquid containing section on the tapered distal end side from the tight fit preventing part.

4. The disposable pipette tip of claim 1, wherein
the tight fit preventing part comprises a projection which projects from the external surface of the liquid containing section.

5. The disposable pipette tip of claim 1, wherein
the liquid containing section comprises a first part on the tapered distal end side and a second part on the attachment section side, the first part comprising the tight fit preventing part and being continually located to the second part,
the second part has an internal diameter that decreases toward the first part,
and the external diameter of the tight fit preventing part is larger than the internal diameter of the end of the second part on the first part side.

6. The disposable pipette tip of claim 5, wherein
the liquid containing section comprises a third part being continually located to the attachment part and the second part.

7. The disposable pipette tip of claim 5, wherein
the first part has an internal diameter that increases at a first rate from the tapered distal end toward the end of the first part on the second part side,
and the second part has an internal diameter that increases at a second rate from the end of the first part on the second part side toward the attachment section, the second rate being greater than the first rate.

8. The disposable pipette tip of claim 5, wherein
the inner surface of the first part is a smoothly continuous surface.

9. The disposable pipette tip of claim 1, wherein
length of the first part is larger than that from the end of the second part on the first part side to the end of the attachment section on the opposite side of the second part.

10. A disposable pipette tip used in a dispensing device, comprising:
an attachment section for being attached to the dispensing device; and
a body being continually located to the attachment section,
wherein the body comprises a tapered distal end part, a first part being continually located to the tapered distal end part, and a second part being continually located to the first part and having an internal diameter that decreases toward the first part,
and wherein the external diameter of the end of the first part on the tapered distal end part side is larger than the internal diameter of the end of the second part on the first part side.

11. The disposable pipette tip of claim 10, wherein
the body comprises a third part being continually located to the attachment section and the second part.

12. The disposable pipette tip of claim 10, wherein
the first part is continually located to the tapered distal end part in step-like manner, such that the external diameter of the end of the first part on the tapered distal end side is larger than that of the end of the tapered distal end part on the first part side.

13. The disposable pipette tip of claim 10, wherein
a projection is formed at the end of the first part on the tapered distal end part side, which projects from the external surface of the first part.

14. The disposable pipette tip of claim 10, wherein
length from the distal end of the tapered distal end part to the end of the first part on the second part side is larger than that from the end of the second part on the first part side to the end of the attachment on the opposite side of the second part.

15. A disposable pipette tip used in a dispensing device, comprising:
an attachment section for being attached to the dispensing device;
a tapered part having a tapered shape; and
an intermediate portion being continually located to the attachment section and the tapered part,
wherein the tapered part comprises a tight fit preventing part which is located adjacent to the distal end of the tapered part and prevents a tight fit with another pipette tip.

16. The disposable pipette tip of claim 15, wherein
the external diameter of the tight fit preventing part is larger than the internal diameter of the end of the tapered part on the intermediate portion side.

17. The disposable pipette tip of claim 15, wherein
the tight fit preventing part comprises a stepped part having an external diameter that is larger than that of the tapered part on the distal end side from the tight fit preventing part.

18. The disposable pipette tip of claim 15, wherein
the tight fit preventing part comprises a projection which projects from the external surface of the tapered part.

19. The disposable pipette tip of claim 15, wherein
the intermediate portion comprises a first part on the tapered part side and a second part on the attachment section side,
and the first part has an internal diameter that decreases toward the tapered part.

20. The disposable pipette tip of claim 19, wherein
the tapered part has an internal diameter that increases at a first rate from the distal end toward the end of the tapered part on the intermediate portion side,
and the first part has an internal diameter that increases at a second rate from the end of the tapered part on the first part side toward the second part, the second rate being greater than the first rate.
